(19) United States
(12) Patent Application Publication
(10) Pub. No.: US 2003/0133783 A1
(43) Pub. Date: Jul. 17, 2003

(54) Fluid driven generator

(76) Inventors: Gerald E. Brock, Livonia, NY (US); Garry P. Haltof, Penfield, NY (US); Howard J. Greenwald, Rochester, NY (US)

Correspondence Address: GREENWALD & BASCH, LLP, 349 WEST COMMERCIAL STREET, SUITE 2490, EAST ROCHESTER, NY, 14445, US

(21) Appl. No.: 10/100,368

(22) Filed: Mar. 18, 2002

Related U.S. Application Data
(60) Provisional application No. 60/276,938, filed on Mar. 20, 2001.

(51) Int. Cl. F03D 7/00

(52) U.S. Cl. 415/4.2

(57) ABSTRACT

A fluid-driven power generator that contains a turbine within a housing, a device for directing fluid towards the tangential portions of the turbine, and a device for creating a venturi flow of fluid within the housing. The fluid flowing around the turbine is constricted for at least about 120 degrees of its flow around the turbine.

### CROSS-REFERENCE TO RELATED PATENT APPLICATION

Priority for this application is based upon applicants' provisional application 60/276,938, filed on Mar. 20, 2001.

### FIELD OF THE INVENTION

A fluid driven coaxial electrical generator that is disposed within a fluid directing, velocity amplifying cowling.

### BACKGROUND OF THE INVENTION

Wind-driven power generators have been known for hundreds of years. Many of these prior art generators are large and cumbersome and, thus, cannot readily be used within small confined spaces.

It is an object of this invention to provide an efficient, compact wind-driven power generator.

It is another object of this invention to provide a more efficient power generator than is available in the prior art.

### SUMMARY OF THE INVENTION

In accordance with this invention, there is provided a fluid-driven power generator comprised of a turbine disposed within a cowling, wherein the front of said cowling is comprised of means for directing fluid towards the tangential portions of said turbine.

### BRIEF DESCRIPTION OF THE DRAWINGS

The invention will be described by reference to the following drawings, in which like numerals refer to like elements, and in which:

FIG. 1 is a sectional view of one preferred fluid-driven generator of the invention;

FIG. 2 is a sectional view of another preferred fluid-driven generator of the invention;

FIG. 3 is a sectional view of yet another preferred fluid-driven generator;

FIG. 4 is a sectional view of another preferred fluid-driven generator;

FIG. 5 is a sectional view of the generator of FIG. 1;

FIG. 6 is a sectional view of another fluid generator of the invention;

FIG. 7 is a sectional view of another fluid generator;

FIG. 8 is sectional view of yet another fluid generator of the invention;

FIG. 9 is a sectional view of a generator impeller;

FIG. 10 is a sectional view of yet another generator;

FIG. 11 is an exploded view of the generator of FIG. 10;

FIG. 12 is a sectional view of another generator of the invention;

FIG. 13 is a sectional view of the impeller of the generator of FIG. 12;

FIGS. 14 and 15 are partial perspective views of another generator of the invention;

FIG. 16 is a sectional view of the generator of FIGS. 14 and 15;

FIG. 17 is a perspective view of a generator assembly; and

FIGS. 18A, 18B, 18C, 18D, and 18E illustrate components of a housing for a generator.

### DESCRIPTION OF THE PREFERRED EMBODIMENTS

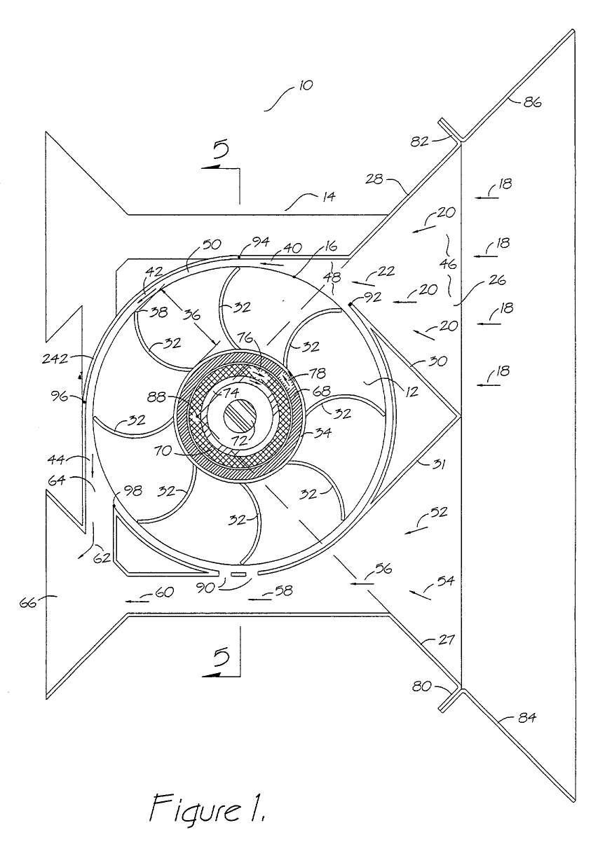

FIG. 1 is a sectional view of one preferred fluid-driven generator 10. In the preferred embodiment depicted, generator 10 is a counter-rotating tube turbine generator.

Referring to FIG. 1, it will be seen that generator 10 is comprised of a turbine impeller 12 disposed within a shroud 14.

In the preferred embodiment depicted in FIG. 1, shroud 14 is comprised of means for directing incoming fluid towards a first tangential portion of the turbine impeller 12. In the embodiment depicted, a fluid, such as air, flows in the direction of arrows 18, 20, and 22 until it tangentially impacts the turbine impeller 12 at point 16. The means disclosed for so directing the fluid towards tangential point 16 is funnel 26.26 puts air into bypass also

In the embodiment depicted in FIG. 1, funnel 26 is comprised of sidewall 28 and sidewall 30.

One particular turbine impeller 12 is depicted in FIG. 1. However, other turbine impeller configurations also may be used. Reference may be had, e.g., to U.S. Pat. Nos. 6,249,058 (generator having counterrotating armature and rotor), 6,172,429 (hybrid energy recovery system), 4,606,697 (wind turbine generator), 4,328,428 (windspinner electricity generator), 4,075,545 (charging system for automotive batteries), 4,061,926 (wind driven electrical generator), 4,057,270 (fluid turbine), 3,974,396 (electrical generator), 3,697,765, and the like. The entire disclosure of each of these United States patents is hereby incorporated by reference into this specification.

The United States patents described in the prior paragraph relate to counter-rotating wind generators comprising two cylindrical impellers. The United States patents described in this paragraph refer to counter-rotating wind generators with two propeller-type impellers. See, e.g., U.S. Pat. Nos. 6,278,197 (contra-rotating wind turbine system), 6,127,739 (counter-rotating wind turbine), 5,506,453 (conversion of wind energy to electrical energy), 4,038,848 (wind operated generator), and the like. The entire disclosure of each of these United States patents is hereby incorporated by reference into this specification.

Referring again to FIG. 1, and in the preferred embodiment depicted therein, the turbine impeller 12 is comprised of a multiplicity of impeller vanes 32 which, in the embodiment depicted, are arcuate. These vanes 32 are preferably radially disposed around impeller core 34.

In the embodiment depicted, the vanes 32 are preferably equidistantly spaced around impeller core 34. Thus, inasmuch as there are 8 vanes depicted in the embodiment of FIG. 1, such vanes a preferably disposed 45 degrees from each other around impeller core 34. As will be apparent, fewer or more such vanes 32 may be used. Thus, e.g., one may use as few as two such vanes 32 up to as many as, e.g., 100 such vanes 32. It is preferred, in one embodiment, to utilize from about 4 to about 16 such vanes 32. In one embodiment, from about 6 to about 12 such vanes 32 are used.

Referring again to FIG. 1, each vane 32 was a height 36 extending from the impeller core 34 to the tip 38 of the vane 32. In the apparatus 10 of this invention, it is preferred that most of the fluid (such as air) be directed to impact the vanes 32 at a point or points that are located more than 50 percent of the distance from core 34. Without wishing to be bound to any particular theory, applicant believes that when fluid/air is directed to the top half of the impeller vanes 32, the turbine will operate more efficiently. Thus, when reference is made in this specification to tangentially directing the fluid/air to the impeller 12, it should be understood that such air is preferentially directed towards the top half of the impeller vanes 32.

Referring again to FIG. 1, the fluid/air that tangentially contacts the vane(s) 32 at point 16 then flows in the direction of arrows 40, 42, and 44 while it simultaneously contacts vanes 32 during such passage. Because the air flows from an area of greater volume 46 to an area of smaller volume 48 and to an area of yet smaller volume 50, the velocity of the air flow will increase, and the efficiency of the turbine assembly 10 will also increase.

In one embodiment, depicted in FIG. 1, air flows both in the direction of arrows 52, 54, 56, 58 and combines with air flowing in the direction of arrow 62 through exhaust tubes 64 and 66. As will be apparent, a venturi effect is created by the intersection of these two air flows, resulting in a force pulling air from tube 66 out of exhaust tube 64. Reference may be had, e.g., to U.S. Pat. Nos. 5,600,106, 5,550,334,5,280,827, 6,045,060, 6,042,089, and the like. The entire disclosure of each of these United States patents is hereby incorporated by reference into this specification. As is known to those skilled in the art, this venturi effect causes a drop in pressure.

In one embodiment, not shown, the sidewalls 27 and 31 are omitted from the structure, and no venturi effect is created.

Referring again to FIG. 1, and in the preferred embodiment depicted therein, a magnet 68 is caused to rotate around a counter-rotating coil 70. Such a structure in which a coil is rotated in one direction and a magnet is rotated in another direction is well known. Reference may be had, e.g., to U.S. Pat. Nos. 6,249,058, 6,172,429, 4,606,697, 4,328,428, 4,075,545, 4,061,926, 4,057,270,3,974,396, 6,278,197, 6,127,739, 5,506,453, 4,039,848, 5,783,894,5,262,693, 5,089,734, 4,056,746, 4,021,690, 3,925,696,3,191,080, 2,696,585, and the like. The entire disclosure of each of these United States patents is hereby incorporated by reference into this specification.

In the embodiment depicted in FIG. 1, shaft 72 does not rotate. Connected to shaft 72 by means of bearings (not shown in FIG. 1) is a tube 74 to which the coil 70 is attached. This tube 74/coil 70 assembly is induced to rotate in one direction 76, whereas the magnet 68 is induced to rotate in the opposite direction 78. As will be apparent, these directions can be reversed as long as the magnet 68 and the coil 70 each rotate in directions opposite to each other.

Referring again to FIG. 1, and in the preferred embodiment depicted therein, it will be seen that shroud 14 is comprised of flanges 80 and 82 which allow the addition of funnel sections 84 and 86. As will be apparent, depending upon the length of funnel sections 84 and 86, and/or their configuration(s), one can vary the amount of funneling effect exerted upon incoming air. It is preferred that the funnel sections 84 and 86, when extending an imaginary intersection point 88, form about a ninety degree angle. Put another way, each funnel section 84 and 86 should form an acute angle with a line bisecting the intersection point 88, such acute angle varying from about 30 to about 45 degrees.

Referring again to FIG. 1, and in the preferred embodiment depicted therein, shroud 14 is comprised of a multiplicity of weep holes 90 to allow the escape of moisture and/or excess air into exhaust tube 66.

In the embodiment depicted in FIG. 1, each of the magnet 68 and the coil 70 is shown as being one continuous, integral element. In another embodiment, not shown, the magnet 68 and/or the coil 70 is comprised of separate, non-integral elements which also may be non contiguous. In the embodiment depicted in FIG. 1, the air flowing around the turbine impeller 12 is confined by shroud 14, that provides a relatively small passageway or passageways, for input and exhaust of such fluid. As will be seen from FIG. 1, only from points 92 to 94, and from points 96 to 98, is the fluid/air relatively unconstricted. It is preferred to constrict the fluid/air over at least 90 degrees of the periphery of the turbine impeller 12, and, more preferably, at least about 120 degrees of such periphery. In one embodiment, the fluid/air is constricted over at least about 150 degrees. In another embodiment, the fluid/air is constricted over at least about 300 degrees. When the air is so constricted, its pressure is superatmospheric, being greater than about 14.7 pounds per square inch.

In the embodiment depicted in FIG. 1, the unconstricted area between points 92 and 94 is about the same as the unconstricted area between points 96 and 98. In another embodiment, not shown, the former unconstricted area is larger than the latter unconstricted area. In yet another embodiment, not shown, the latter unconstricted area is larger than the former unconstricted area. As will be apparent, by varying the properties and sizes of such unconstrictued areas, one will affect the air flow through the device 10.

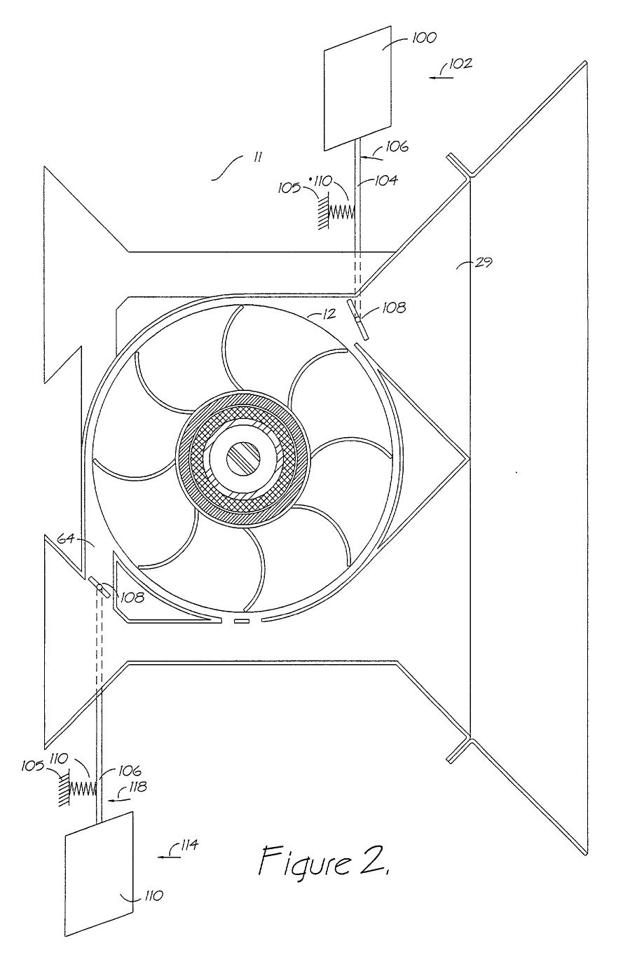

FIG. 2 is a sectional view of another turbine assembly 11 from which unnceccessary detail and/or identification has been omitted for the sake of simplicity of representation. Referring to FIG. 2, it will be seen that the turbine assembly 11 is comprised of means 100 for varying the volume of air flowing into the turbine impeller assembly, and the volume of air exiting the turbine assembly.

Referring to FIG. 2, and in the preferred embodiment depicted therein, it will be seen that, pivotally attached to shroud sidewall 29 is sail 100. As air flowing in the direction of arrow 102 forces sail 100 to move in the same direction, it displaces arm 104 in a counterclockwise direction 106. When arm 104 is displaced in direction 106, it causes butterfly valve 108 to move, to open, and to allow air flow through it; in the embodiment depicted, biasing means 110 is connected between arm 104 and stationary element 105. Thus, the movement of sail 100 allows an increased volume of air to flow into the impeller 12.

Conversely, when the amount of air flowing in the direction of arrow 102 decreases, the butterfly valve 108 will tend to close and decrease the amount of air flowing into the impeller 12. Thus, the device 11 is self-regulating. As the velocity of the fluid/air impacting it changes, the amount of fluid/air allowed through it also changes.

Referring again to FIG. 2, and in the embodiment depicted, a similar sail assembly is connected to the exhaust tube 64 of the device. In this embodiment, although a butterfly valve 108 is depicted, it will be apparent that other suitable valve assemblies and/or techniques may be used.

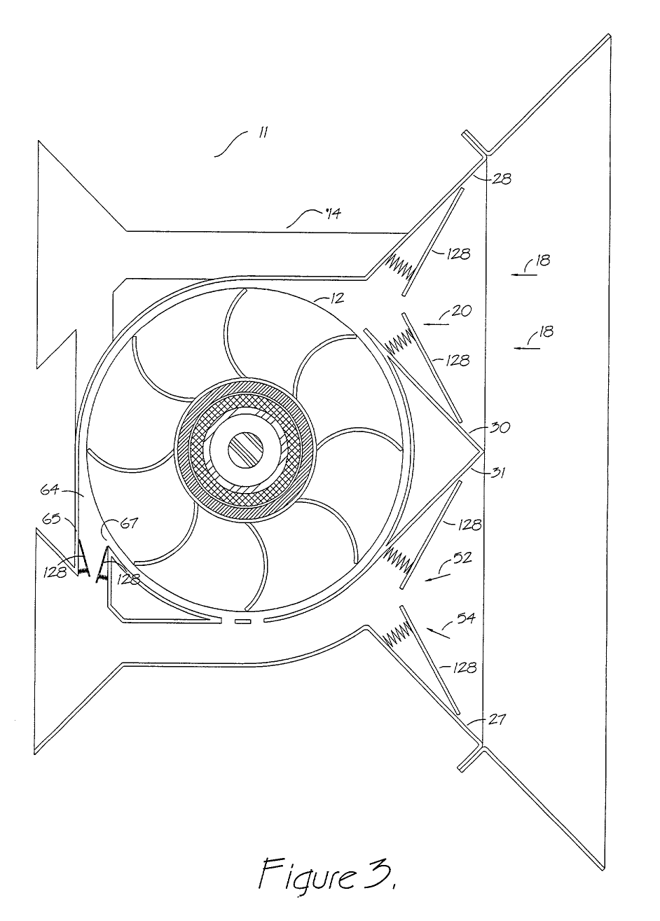

Other means for effecting this self-regulation function also may be used. Thus, for example, in the embodiment depicted FIG. 3, spring-biased valve assemblies 128 may be connected to sidewall 28 and/or sidewall 30 and/or exhaust tube wall 65 and/or exhaust tube wall 67. As air impacts one or more of such spring-biased valve assemblies, it causes such assemblies to deflect and thereby change the shape and the volume of the air intake or air exhaust ports. Such deflection will increase the amount of air allowed to enter or exit the assembly. Conversely, when the air speed decreases, the spring-biased valve assemblies will expand, and the amount of air allowed to enter or exist the ports will decrease.

Referring again to FIG. 3, and in the preferred embodiment depicted therein, spring-biased assemblies 128 will change their configurations as the wind speed entering in the directions of arrows 18 and 20 changes, and/or as the wind speed through orifice 64 changes. As will be apparent, the device depicted in FIG. 3 automatically adjusts the amount of intake and exhaust air depending upon such wind speeds.

Similarly, the spring biased assemblies 128 attached to sidewalls 27 and 31 adjust their configurations based upon the wind speed of air flowing in the directions of arrows 52 and 54.

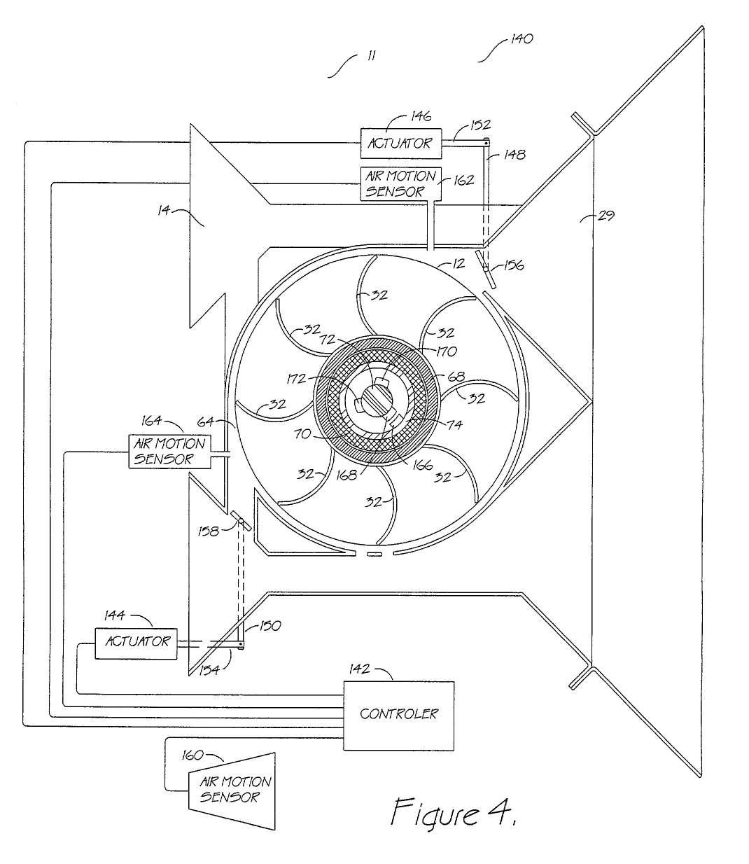

In another embodiment, illustrated in FIG. 4, a turbine assembly 140 is illustrated. Referring to FIG. 4, turbine assembly 140 is comprised of a controller 142 operatively connected to actuator 144 and 146.

Each of the actuators 144 and 146 is connected to an arm, 148 and 150, respectively. Each of arms 148 and 150 is pivotally connected to an actuator arm 152 and 154, respectively. Each of actuator arms 152 and 154 are connected to valves 156 and 158, respectively. As valves 156 and 158 change their position, the amount of air entering the turbine impeller 12, and the amount of air exiting the turbine impeller 12, be varied.

The positions of valves 156 and 158 may be independently varied by controller 142. Controller 142 receives information from air motion sensor 160, to which it is operatively connected. Such a connection may be made by a direct line; alternatively, such a connection may be made by telemetric means.

As will be apparent, the controller 142 may choose to vary the amount of air entering and/or exiting the assembly 140 depending upon, e.g., the amount of air flow exterior to the device. Alternatively, or additionally, the controller 142 may choose to vary the amount of air entering and/or exiting the assembly based upon data of air flow within the device 140. This data may be provided by means of air motions sensors 162 and 164, each of which is operatively connected to the controller 142.

Regardless of the means used, the sensors convey information to the controller 142 regarding the speed of rotation of turbine 12 as well as the wind flow within and without the turbine assembly.

Referring again to FIG. 4, and in the preferred embodiment depicted therein, it will be seen that assembly 140 is comprised of a rotation counter operatively connected (not shown)to the controller 142. In the embodiment depicted, a magnet 166 connected to the inner side of tube 74 comprises a Hall effect (or similar) sensor 168. Similar Hall effect sensors 170 and 172 are radially disposed about the shaft 72. These Hall effect sensors are well known. Reference may be had, e.g., to U.S. Pat. Nos. 5,502,283, 4,235,213, 5,662,824, 4,124,936, 5,542,493, and the like. The entire disclosure of each of these United States patents is hereby incorporated by reference into this specification.

In another embodiment, motion sensors other than Hall effect sensors are used.

In another embodiment, not shown, a plurality of magnets are disposed on the inside of tube 74.

In yet another embodiment, the electrical output of the turbine is measured by an ammeter and/or a voltmeter (not shown) operatively connected to the controller 142. In yet another embodiment, not shown, the electrical load on the turbine 12 is measured by means (not shown) operatively connected to the controller 142.

In yet another embodiment, other environmental factors, such as the ambient temperature and the relative humidity, and the air density are sensed by the appropriate sensors and communicated to controller 142.

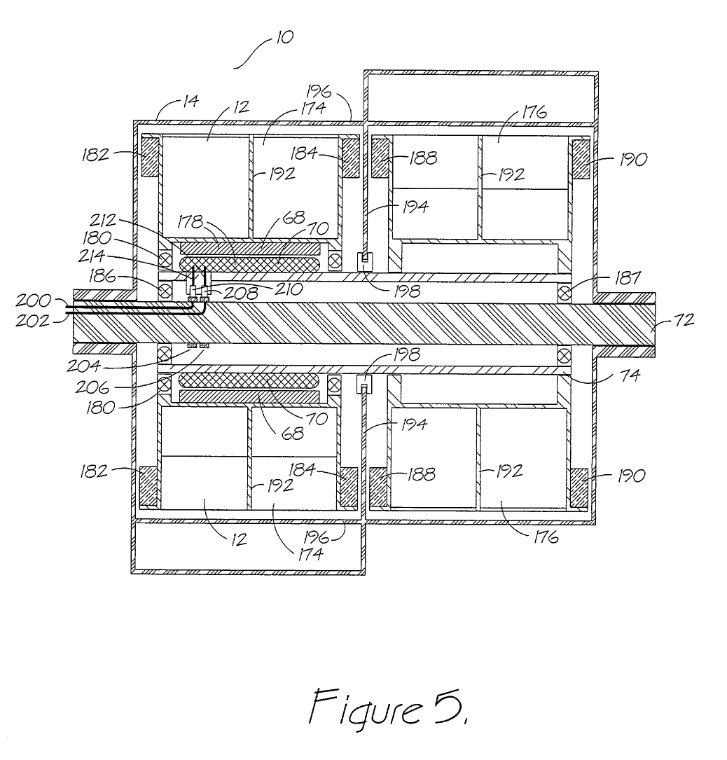

FIG. 5 is a sectional view of the turbine assembly 10, taken along lines 5-5 of FIG. 1. Referring to FIG. 5, it will be seen that assembly 10 is comprised of shroud 14, disposed within which is turbine assembly 174 and turbine assembly 176.

Turbine assembly 174 is a generator turbine, i.e., it is connected to generator 178. In the embodiment depicted, generator 178 is comprised of coil 70 and magnet 68.

In the embodiment depicted, the magnet 68 is connected to the generator turbine impeller 12 and rotates in one direction. The coil 70 is connected to tube 74 that is rotated by tube turbine 176 in a counter-rotating direction. Thus, as will be apparent, with this counter-rotating arrangement, the same amount of wind will cause about twice the relative motion between the coil 70 and the magnet 68.

Referring again to FIG. 5, the generator turbine 174 is rotatably mounted on turbine bearings 180, and flywheel weights 182 and 184 help maintain the inertia of generator turbine 174. Similarly, the tube turbine 176 is mounted on the tube 74 which, in turn, is rotatably mounted on tube bearings 186 and 187; the inertia of the tube is maintained by the flywheels 188 and 190. In the preferred embodiment depicted in FIG. 5, the tube bearings 186 and 187 are preferably mounted on stationary shaft 72.

In the preferred embodiment depicted in FIG. 5, reinforcing ribs 192 are used to reinforce the turbine impeller blades 32 (see FIG. 1).

Referring again to FIG. 5, it will be seen that shroud 14 is comprised of shroud separator wall 194 that extends from the outside wall 196 of the shroud to seal 198 and isolates the air system within turbine assembly 174 from the air system within turbine assembly 176.

In the embodiment depicted in FIG. 5, electricity is removed via conductors 200 and 202 that communicate with commutator rings 204 and 206, brushes 208 and 210, and coil connectors 212 and 214.

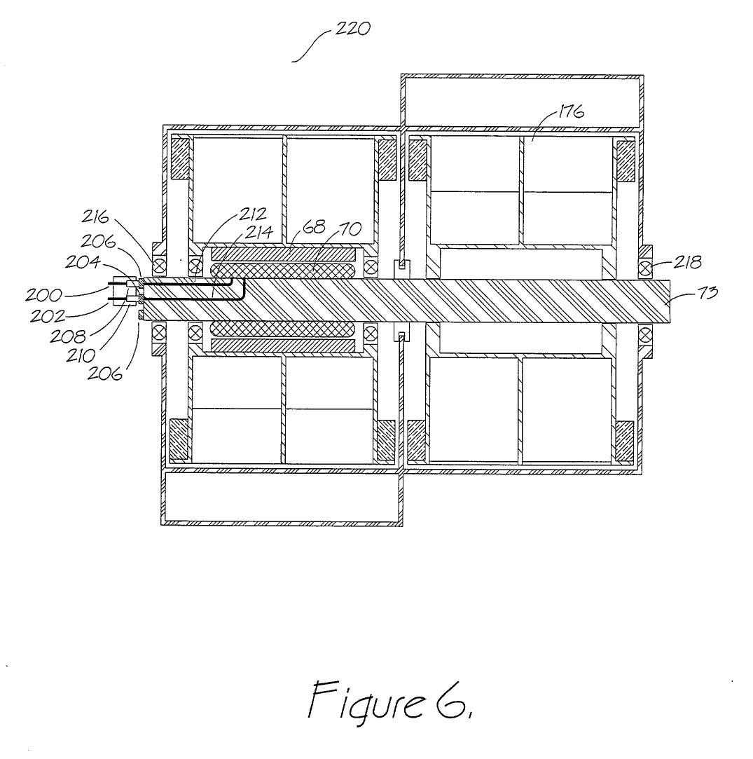

FIG. 6 is a sectional view of a turbine assembly 220. The assembly 220 differs from the assembly 10 in that tube 74 is omitted; shaft 73 is rotatable, being operatively connected to turbine 176; the coil 70 is mounted on rotatable shaft 73; bearings 216 and 218 support shaft 73; and the conductors 200/202, the commutator rings 204 and 206, the brushes 208 and 210 and the coil connectors 212 and 214 have different locations, as shown.

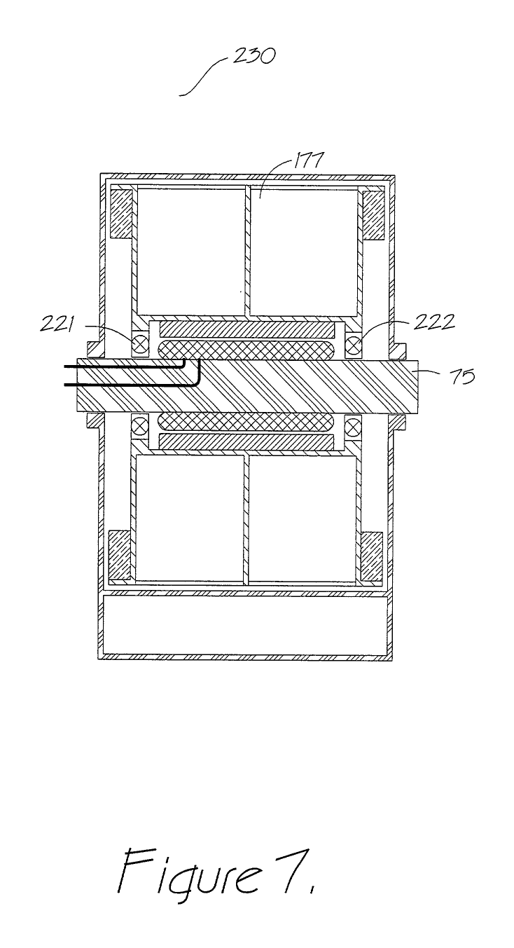

FIG. 7 is a sectional view of a turbine assembly 230. In this embodiment, there is only one turbine assembly 177 rotating around a fixed shaft 75 on bearings 221 and 222.

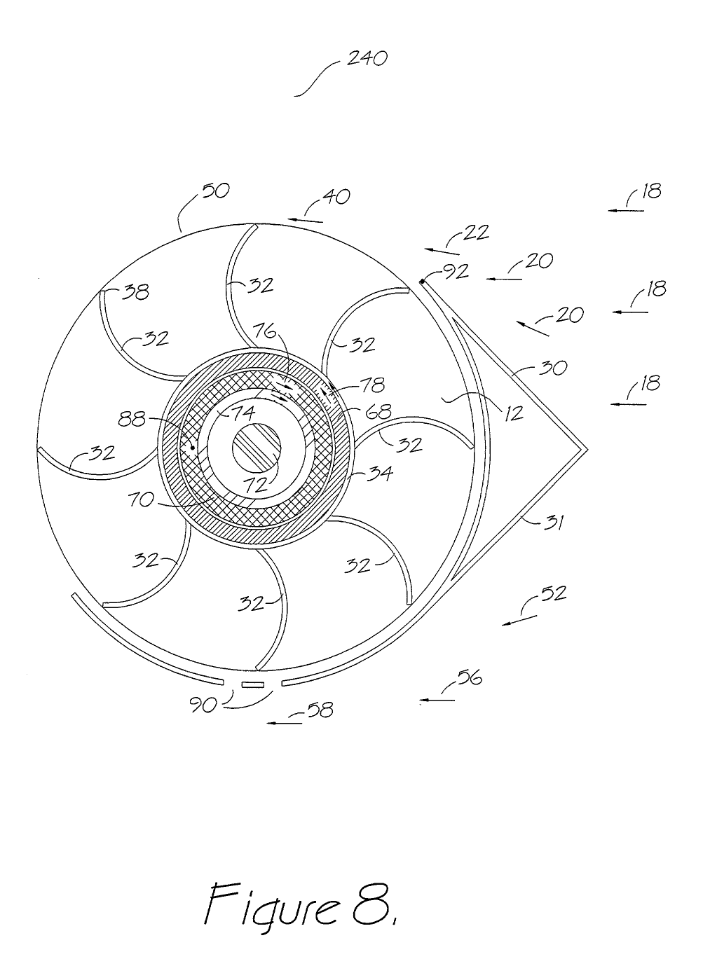

FIG. 8 is a sectional view of a turbine assembly 240 which is similar to the turbine assembly depicted in FIG. 1 but omits certain elements of shroud 14, such as sidewalls 86, 28, 84, and 27. In addition, and referring to Figure, portion 242 of shroud 14 also is omitted, as are the walls that comprise exhausts 64 and 66. As will be apparent, although FIG. 8 depicts the device 240 rotating in one direction, it may also be connected to as similar device rotating in the opposite direction (see FIG. 5).

In one embodiment, the device of FIG. 8 is mounted on a tower. In another embodiment, the device of FIG. 8 is mounted on a rooftop. The devices of FIG. 8, and of the other Figures in this case, tend to vibrate less than prior art devices and, thus, are more suitable for many applications, including mounting on buildings.

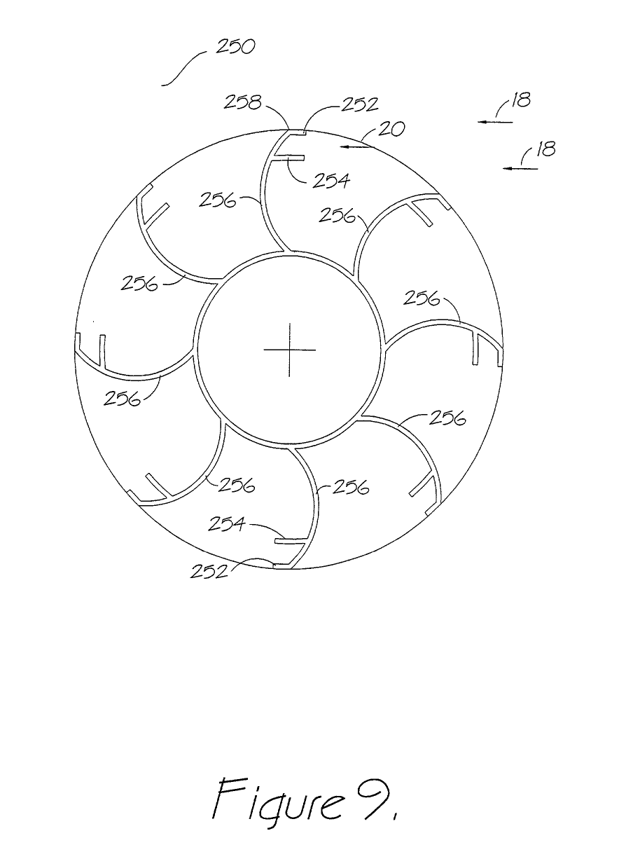

FIG. 9 is a sectional view of another turbine impeller 250 which is similar to turbine impeller 12 that comprises turbine impeller blade ribs 252 and 254. These ribs 252 and 254 are preferably located in the top third of the impeller blades 256; and they generally have a length that is at least about 0.1 times as great as the length of the impeller blades 256. These ribs 252 and 254 are adapted to stiffen the impeller blades 256 and concentrate the force created by the air flow 18 and 20 impacting the turbine blades 256 to the periphery 258 of turbine impeller 250, thereby increasing the mechanical advantage of air flow 18 and 20 and therefore the force exerted on the generator system.

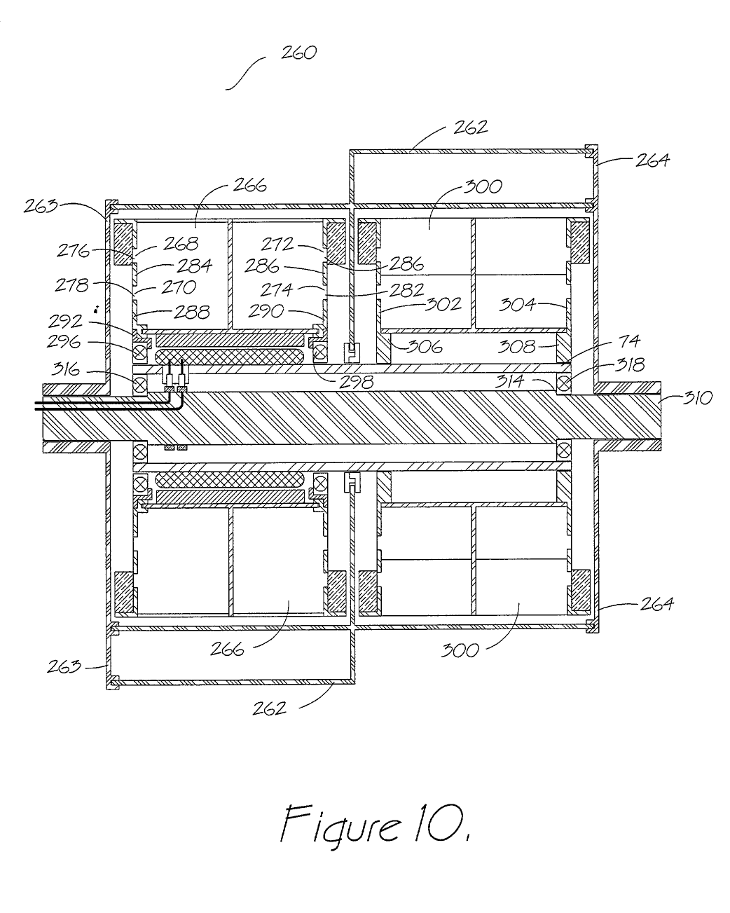

FIG. 10 is a sectional view of a turbine assembly 260. The assembly 260 differs from the assembly 10 (see FIG. 5) in assembly 260 can be readily assembled and disassembled. Turbine assembly 260 is comprised of a central shroud structure 262, shroud end caps 263 and 264, and generator turbine impeller 266; turbine impeller 266 has assembly tabs 268, 279, 272, and 274 that insert into receiving slots 276, 278, 280, and 282 respectively.; and the receiving slots 276, 278, 280, and 282 are radially disposed on sidewalls 284 and 286 of turbine impeller hubs 288 and 290 respectively).

The assembly 260 also is comprised of central hubs 292 and 294 that position generator bearings 296 and 298 therebetween, and by their presence, position and rotationally support generator turbine impeller 266 about unchanged tube 74.

Referring again to FIG. 10, and in a manner similar to generator turbine impeller 266, generator turbine impeller 300 has assembly tabs that insert into receiving slots that are radially disposed on sidewalls 302 and 304 of turbine impeller hubs 306 and 308). Shaft 310 has steps 312 and 314 that position tube bearings 316 and 318, and seal 320 comprised of seal half 322 and 324 positioned on tube 74.

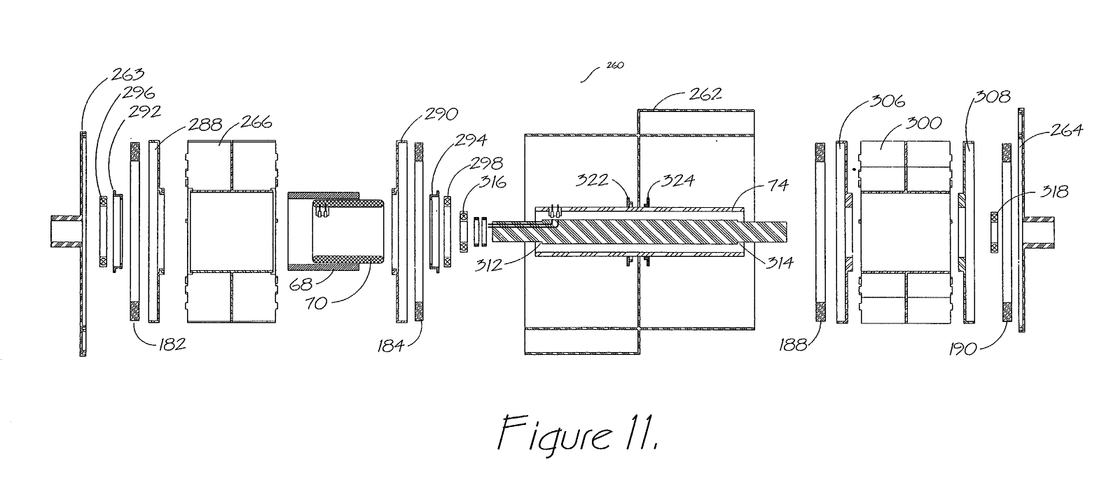

FIG. 11 is an exploded view of turbine assembly 260.

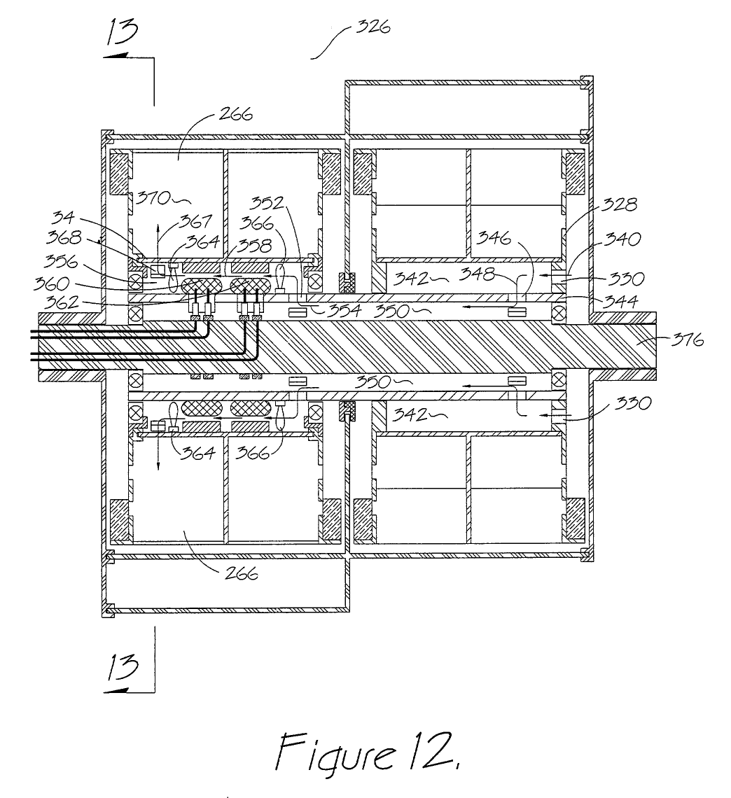

FIG. 12 is a sectional view of a turbine assembly 326. The assembly 326 differs from the assembly 260 in that, in the former assembly, turbine sidewall 328 has 2 to 10 radially disposed slots 330 that permit air flow 340 to enter area 342. Tube 344 has radially disposed slots 346 to permit continued air flow 348 to enter area 350. Tube 344 has a second set of radially disposed slots 352 to again permit air flow 354 into generator housing area 356 where air flow 358 passes around and between one, or more generator assemblies 360 and 362 to carry away heat produced by the generators. Air flow is assisted through area 356 by fan blade assemblies 364 and 366 to exhaust as air flow 367 from area 356 through radially disposed slots 368 in generator impeller core 34 of impeller assembly 266 into area 370 where the heated air is dissipated. It should be noted that a plurality of conductors 372 and 374 can be located in shaft 376. Other means of providing air circulation by using the rotary motion of one or more of the turbine may be used to assist in propelling cooling air the generator area. It should also be noted that different generator designs with varying power generating capacities may be used.

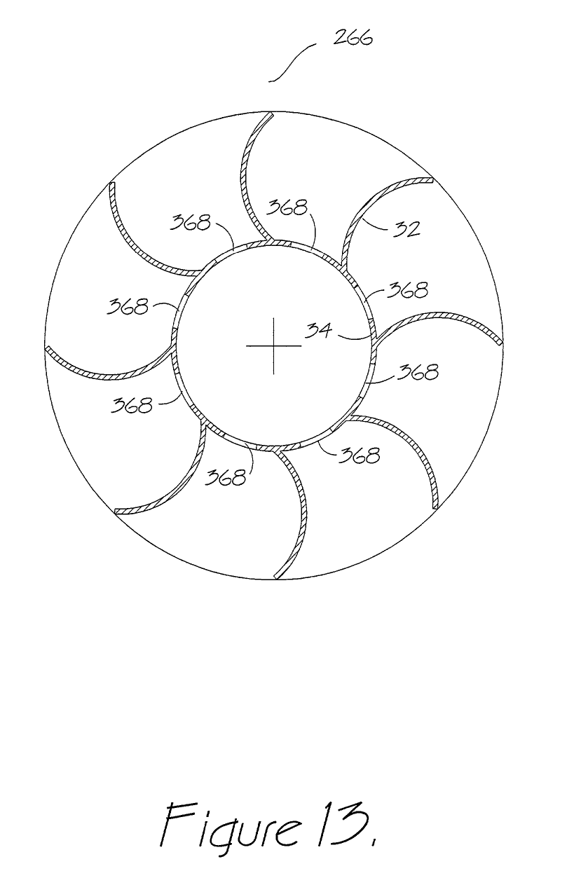

FIG. 13 is a sectional view of generator impeller 266 showing airflow slots 368 in core 34 of impeller 266.

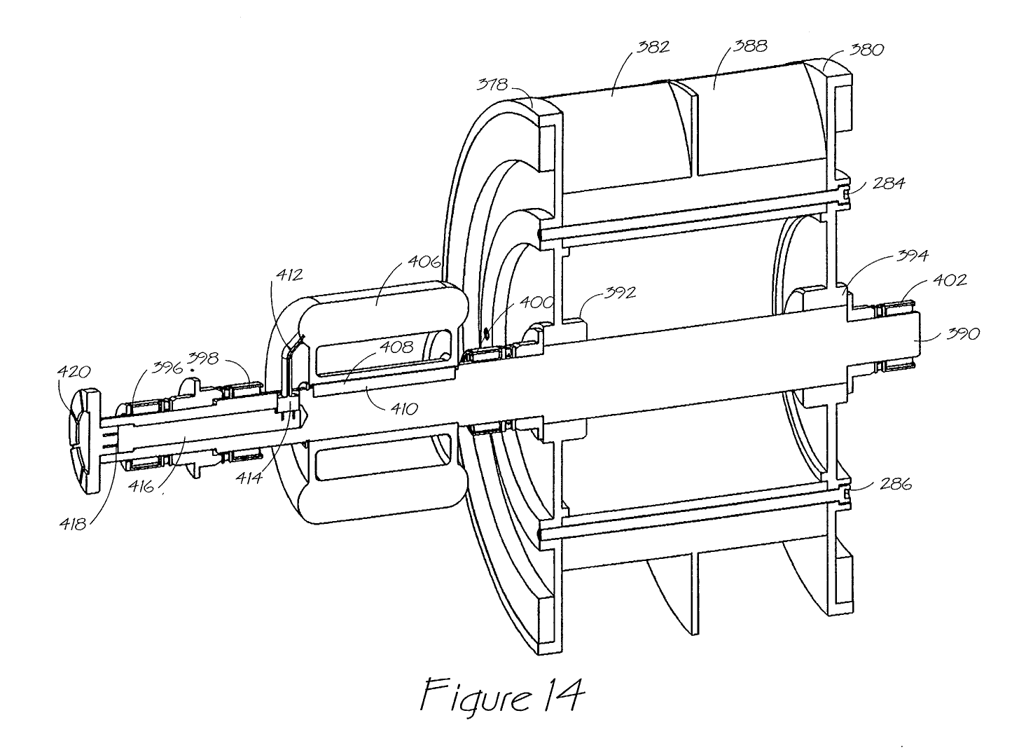

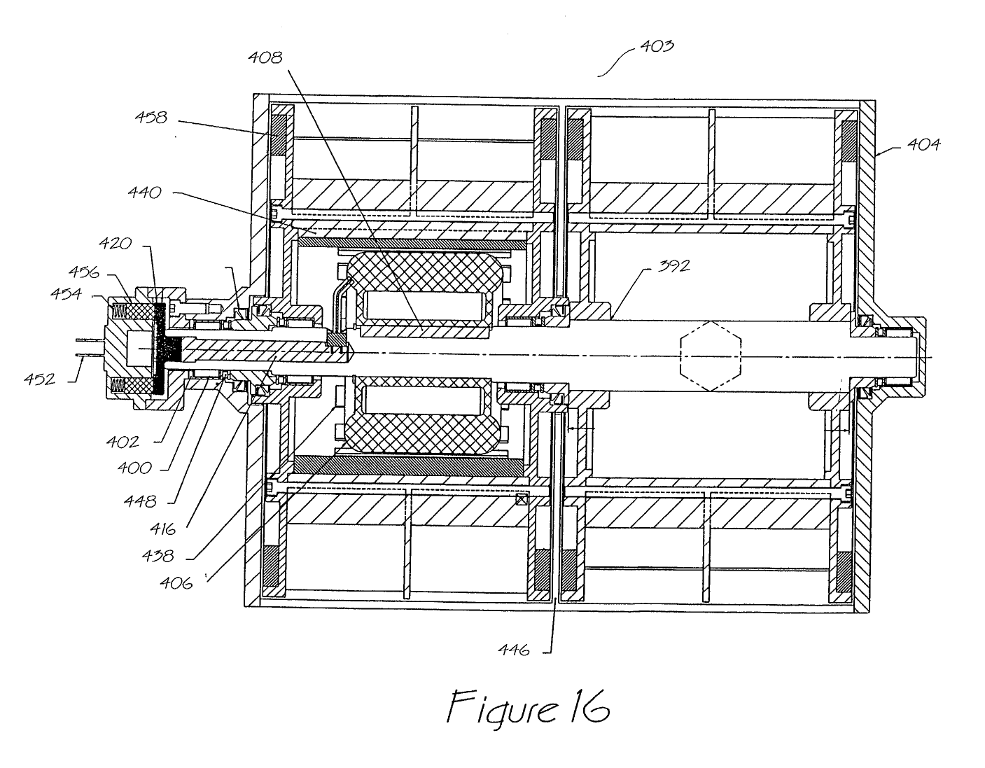

FIG. 14 is a sectioned perspective view of a portion of a turbine generator 403 depicted in FIG. 16. This assembly 403 differs from turbine assembly 220 (see FIG. 6) in that turbine impeller hubs 378 and 380 are held in clamping contact with turbine impeller 382 by bolts 284 and 286 and two or more bolts (not shown). Impeller assembly 388 is rotationally fixed to shaft 390; shaft 390 has a polygonal cross section (not shown) that assembles to holes 392 and 394 of a similarly shaped polygonal cross section (not shown), such holes preferably being centrally located in hubs 378 and 380.

Shaft 390 is supported by bearings 396, 398, 400, and 402 that, in turn, are supported by turbine generator shroud 404 of the turbine generator assembly 403 depicted in FIG. 16. Adjacent to impeller assembly 388 is generator coil 406 that is rotationally fixed to shaft 390 by key 408 in shaft keyway 410 in shaft 390. Electric current generated by the coil is conducted out of the generator by conductor 412, connecter 414, conductor 416, and connecter 418, to commutator 420, all running through and attached to shaft 390.

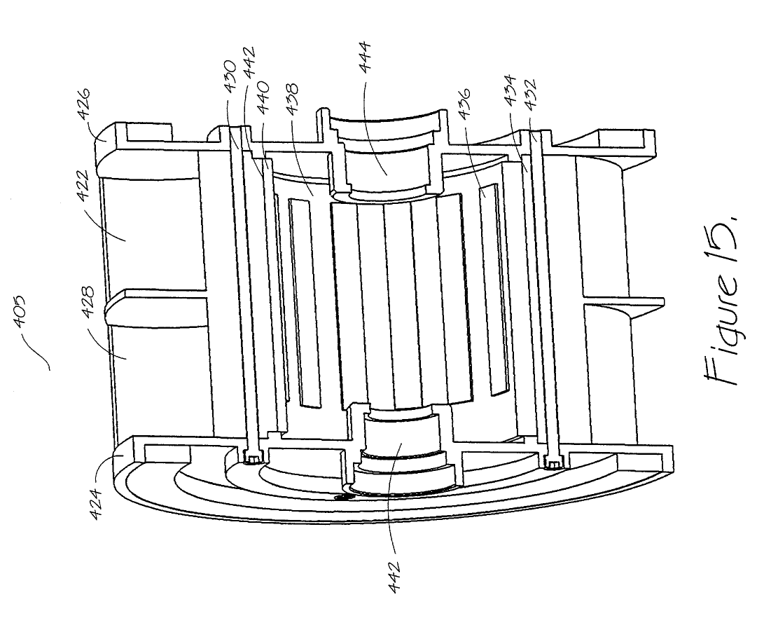

FIG. 15 is sectioned perspective view of the generator impeller portion 405 of turbine generator 403 that differs from turbine assembly 220 in that turbine impeller hubs 424 and 426 are held in clamping contact with turbine impeller 428 by bolts 430 and 432 and two, or more additional bolts (not shown). Radially disposed about interior wall 434 are magnets 436 positioned by a magnet carrier 438 and held in rotational position by key 440 in keyway 442 in interior wall 434 of impeller. Bearing ways 442 and 444 are axially positioned in impeller hubs 424 and 426, respectively, to hold bearings (shown in FIG. 14) 398 and 400, respectively.

FIG. 16 depicts turbine generator 403 comprising a shroud 404 with separating wall 446 enclosing a generator turbine assembly 422; the generator turbine assembly 442 includes a generator key 408, magnet carrier 438 and magnet carrier key 440, turbine impeller assembly 388, shaft 390 in hole 392 with bearings 396, 398, 400 and 402, coil 406 held by key 408 in keyway 410, conductors 412 and 416, connecters 414 and 418, and commutator 420. In the embodiment depicted, the assembly 388 also comprises a conductor 416, a thrust bearing 448, a bearing 400, a trim spacer 402 (to compensate for axial tolerances), a power outlet 452, brush springs 454, and brushes 456.

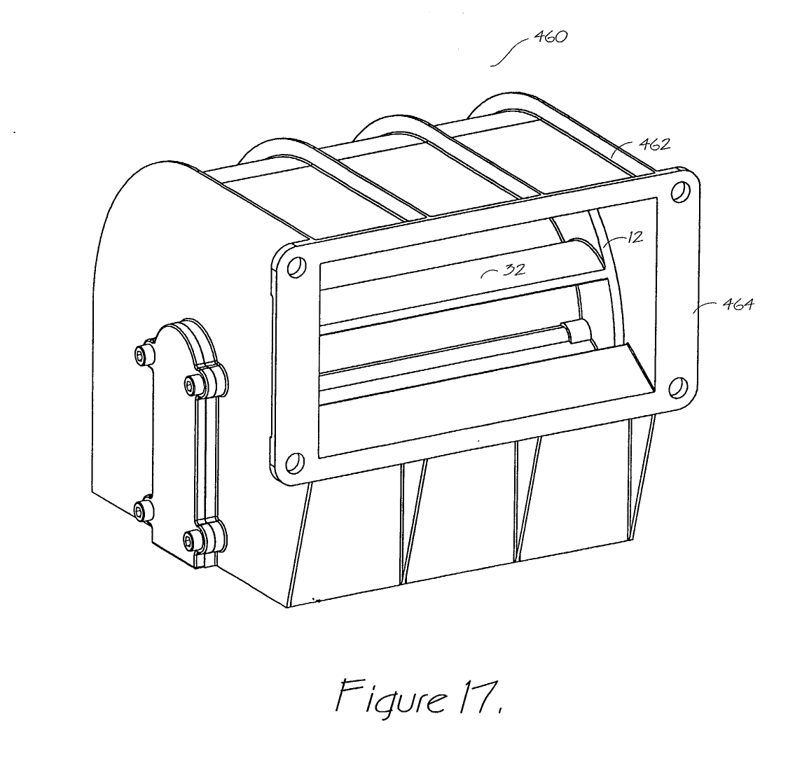

FIG. 17 is a perspective view of a turbine generator 460 within a shroud 462 with mounting flange 464. Mounting flange 464 may be used to attach air-directing sidewalls (not shown) to improve generator performance.

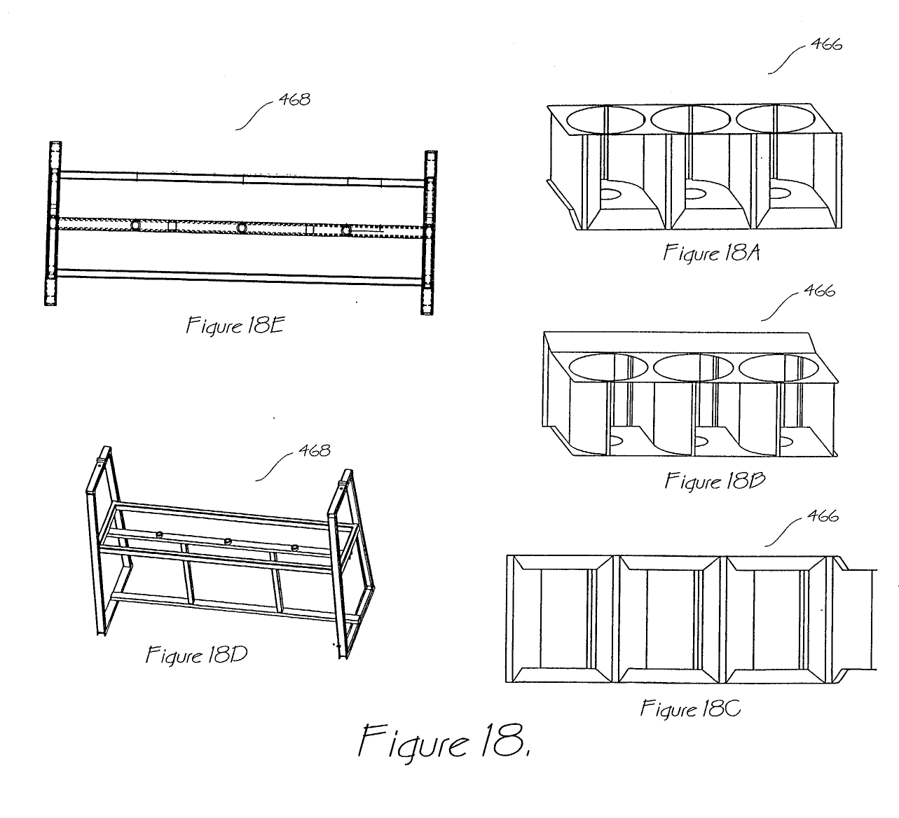

FIG. 18A is a perspective view of a shroud 466 adapted to receive three turbines (not shown). FIG. 18B is a back perspective view of the shroud 466. FIG. 18C is a front view of the shroud 466. FIG. 18D is a perspective view of a support 468 for the shroud 466. FIG. 18E is a top view of the support 468.

It is to be understood that the aforementioned description is illustrative only and that changes can be made in the apparatus, in the ingredients and their proportions, and in the sequence of combinations and process steps, as well as in other aspects of the invention discussed herein, without departing from the scope of the invention as defined in the following claims.

We claim:

1. A fluid-driven power generator comprised of a turbine disposed within a housing, and, also disposed within said housing, means for directing fluid towards the tangential portions of said turbine, and means for creating a venturi flow of fluid within said housing, wherein:
(a) said means for directing fluid towards said tangential portions of said turbine comprises a first interior sidewall, and a second interior sidewall connected to said first sidewall, and
(b) said means for directing fluid towards said tangential portions of said turbine is comprised of means for causing said fluid to flow around said turbine and, for at least about 120 degrees of said flow of said fluid around said turbine, for constricting said fluid and increasing its pressure.

2. The power generator as recited in claim 1, wherein said housing is comprised of a multiplicity of weep holes.

3. The power generator as recited in claim 1, wherein said housing further comprises a funnel connected to the front of said housing.

4. The power generator as recited in claim 3, wherein said funnel is comprised of a first wall and a second wall disposed vis-a-vis each other at an angle of from about 30 to about 45 degrees.

5. The power generator as recited in claim 1, wherein said turbine is a counterrotating turbine.

6. The power generator as recited in claim 1, wherein said turbine is comprised of a turbine impeller assembly.

7. The power generator as recited in claim 6, wherein said power generator is comprised of means for varying the volume of air flowing into said turbine impeller assembly.

8. The power generator as recited in claim 8, wherein said power generator is comprised of means for varying the volume of air flowing out of said turbine impeller assembly.

9. The power generator as recited in claim 8, further comprising a first sail.

10. The power generator as recited in claim 9, further comprising a second sail.

11. The power generator as recited in claim 10, further comprising a first biasing means connected to said first sail and a second biasing means connected to said second sail.

12. The power generator as recited in claim 11, further comprising a first valve connected to said first biasing means and a second valve connected to said second biasing means.

13. The power generator as recited in claim 12, wherein each of said first valve and said second valve is a butterfly valve.

14. The power generator as recited in claim 8, further a controller, a first actuator, and a second actuator.

15. The power generator as recited in claim 14, further comprising an air motion sensor connected to said controller.

16. The power generator as recited in claim 15, further comprising a rotation counter connected to said controller.

17. The power generator as recited in claim 16, comprised of means for measuring the temperature and the relative humidity of ambient air.

18. The power generator as recited in claim 17, comprised of means for measuring the wind speed of ambient air.

19. The power generator as recited in claim 1, further comprising a first turbine rotating in a first direction, a second turbine rotating in a second direction, wherein said first turbine is integrally connected to a rotating tube.

20. The power generator as recited in claim 19, further comprising a fixed shaft disposed within said first turbine and said second turbine.
